(19) United States
(12) Patent Application Publication
(10) Pub. No.: US 2003/0158737 A1
(43) Pub. Date: Aug. 21, 2003

(54) Method and apparatus for incorporating additional audio information into audio data file identifying information

(76) Inventor: Tibor George Csicsatka, San Marcos, CA (US)

Correspondence Address: JOSEPH S. TRIPOLI, THOMSON MULTIMEDIA LICENSING INC., 2 INDEPENDENCE WAY, P. O. BOX 5312, PRINCETON, NJ, 08543-5312, US

(21) Appl. No.: 10/174,028

(22) Filed: Jun. 18, 2002

Related U.S. Application Data
(60) Provisional application No. 60/357,381, filed on Feb. 15, 2002.

(51) Int. Cl. G10L 21/00

(52) U.S. Cl. 704/273

(57) ABSTRACT

A digital audio player (10) and a method for processing encoded digital audio data. The audio data player has a hard disk or other data storage medium (32) for storing data files, a microcontroller (22), buffer memory (25) for anti-skip protection, and an audio decoder (12). The encoded audio data files and associated decoder files are downloaded from a personal computer or similar device to the audio data player hard drive (32). The data structure generally includes a first audio data file having an information segment and an audio data segment. The information segment, generally called a tag, may include textual and graphic information related to the audio data segment. The present invention further includes an additional data frame in the information segment storing one or more audio data files, or “audio tag files”. The audio tag files stored in the information segment include encoded audible or voice recordings that vocalize other tag information related to the audio data segment. The informational audio tag files can be created by processing textual tag information with a text-to-voice converter, or by downloading the informational audio tag files from a server or the Internet. To prevent a data processing device, from inadvertently recognizing the informational audio tag files as stand-alone audio data files, the data structure of the audio tag files may be altered prior to storage in the audio data file.

### CROSS-REFERENCE TO RELATED APPLICATIONS

This application claims the benefit of U.S. Provisional Application Serial No. 60/357,381, filed Feb. 15, 2002, entitled “Method for Incorporating Additional Audio Information Into MP3 Files with an Improvement to ID3 Tags.”

### BACKGROUND OF THE INVENTION

1. Field of the Invention

The present invention relates to an apparatus and a method for processing digitally encoded audio data and features of related music management software.

2. Description of the Related Art

The use of portable audio data players capable of playing digitally encoded audio data has become commonplace. In particular, relatively small handheld devices that can process digitally encoded audio data stored on solid state memory devices have become popular. Additionally, as demand has increased for higher data storage capacity in portable audio data players, another generation of players has been developed and is gaining popularity. These portable audio data players include miniaturized high capacity hard drives that are not as susceptible to skips and other similar problems as are typical hard drives used in personal computers (“PC”) and other applications.

In an audio data player, the digital audio data is loaded into a data storage device by first downloading the data to a PC from an audio CD, the Internet, or another digital audio device. The data is then usually compressed according to a selected encoding format and loaded into the data storage device associated with the audio data player.

The audio data is decompressed/decoded by the audio data player during playback according to the selected encoding format. A variety of encoding formats for compressing and decompressing audio data is available. As used hereinafter, the term encoding format refers to any encoding/decoding scheme that specifies the syntax and semantics of a compressed bitstream and how the bitstream must be decompressed for reproduction. Such encoding formats include, but are not limited to, MP3 and MP3 Pro.

The data structure used for MP3 files include a sequence of interleaved header frames and data frames. Each header frame includes various fields of information that pertain to the data frame that follows, for example, the bit rate used for compressing the data frame that follows. While the compression ratio used for encoding the audio data file may be fixed (constant bit rate or “CBR”) or may vary frame to frame depending upon the complexity of the audio (variable bit rate or “VBR”), the amount of playback time represented by each frame remains the same for MP3 formatted files. Therefore, in a VBR file, the amount of data contained within each data frame will vary, thus presenting difficulties in displaying elapsed play time during playback, especially when forward or backward skipping during the playback of an audio data file. To solve this problem, audio data players generally develop a timekeeping map that must be precompiled prior to playback by reading all of the header frames of an audio data file. Unfortunately, the precompiling of a timekeeping map delays the commencement of playback once an audio data file is selected.

For MP3 encoded audio data files, the data file is prepended or appended with a special set of frames called an ID3 tag. The ID3 tag contains descriptive text and other data relevant to the audio data file. For example, ID3v1 tags are a fixed size of 128 bytes and include title, artist, album, year, genre, and comment fields. ID3v2 provides a flexible tag size of up to 256 MB and adds data frames such as lyrics, pictures, and other defined information data frames. Additionally, ID3v2 enhanced tag moves the ID3 tag from the end to the beginning of an MP3 file. The location of the tag at the beginning of an MP3 file allows the tag information to be easily read before processing the audio data portion of the file. Also, the tag information can be quickly skipped by using header information and pointers embedded in the ID3 tag to go directly to the beginning of the audio data portion of the file.

ID3 tag information is useful for searching, sorting, and selecting specific audio data files based on the information contained in the ID3 tag. Because ID3 tag information is often stored as textual characters or graphics files, the information can be displayed on the display screen of an audio data player. Although such a user interface is useful for finding, selecting, and playing an individual audio data file, having to read the display can be distracting to a person using an audio data player while involved in an activity such as jogging or driving.

Most audio data players utilize a digital signal processor (“DSP”) for performing audio decoding, decompression, and other transformations of the audio data file. For example, the DSP can provide various preset equalization modes or other audio enhancing settings that are useful for quickly selecting a specific playback preference. For example, a preset DSP mode may be specified for specific audio genres such as rock, jazz, and pop. Selection of such preset DSP modes generally requires the user to change the DSP mode during playback by pressing a designated button or selecting the DSP mode from a display menu.

Most PC-based audio data file management programs allow the user to create and edit playlists that can then be downloaded to a portable audio data player and used for playing a select sequence of audio data files. One such form of playlist typically associated with MP3audio data files is known as an M3U list. An M3U playlist consists simply of a text file containing a numbered sequential list of paths or locations of data audio files included in the playlist. Thus, a playlist created on a PC and downloaded to an audio data player may be used to selectively play a sequence of audio data files that are contained in the data storage of the audio data player. However, audio data players generally do not allow a playlist to be created or edited on the audio player itself. Additionally, the M3U file format includes only the file location or path information and a comment field. Thus, the M3U file format does not contain other audio data file information such as the information contained in an ID3 tag of an MP3 audio data file.

### BRIEF SUMMARY OF THE INVENTION

The present invention addresses some of the above-noted limitations of audio data players and audio data files, by providing a data structure including a first audio data file having an information segment and an audio data segment, the information segment storing additional audio data files encoding audible recordings announcing attributes of the audio data segment. In particular, the present invention provides an MP3 file with an improved ID3 tag having an embedded MP3 file for announcing the ID3 tag information on a playback device.

The present invention also provides a method of selecting an audio data file in a data processing device.

Additionally, the present invention provides a method of associating audio tag files with an audio data file by storing the audio tag voice file in the audio data file.

The present invention also provides an audio data player having a microcontroller coupled with data storage and an audio decoder, the microcontroller being capable of locating and selectively playing an audio data file embedded in the information segment of an associated audio data file.

The data structure generally includes a first audio data file having an information segment and an audio data segment. The information segment, generally called a tag, may include textual and graphic information related to the audio data segment. For example, the tag segment may include title, artist, album, year, comment, genre, lyrics, and pictures. The present invention further includes an additional data frame in the information segment storing one or more audio data files, or “audio tag files”. The audio tag files stored in the information segment include encoded audible or voice recordings that vocalize other tag information related to the audio data segment. The informational audio tag files can be created by processing textual tag information with a text-to-speech converter, or by downloading the informational audio tag files from a server or the Internet. To prevent a data processing device, such as a PC or an audio data player, from inadvertently recognizing the informational audio tag files as stand-alone audio data files, the data structure of the audio tag files may be altered prior to storage in a data frame of the informational segment of an audio data file.

The audio data player generally includes a microcontroller coupled with a user interface, data storage, buffer memory, and an audio decoder. The user interface includes an LCD, an audio output, and a keyboard having various multi-way and multi-function switches. The audio data player also provides a universal serial bus (“USB”) port for connection to a PC or other USB-equipped device. By connecting the audio data player to a PC via the USB port, audio data files and audio playlists can be downloaded to the audio data player and stored into data storage. In one embodiment, the data storage comprises a 10 GB hard drive; however, other moving data storage media or solid state memory devices, such as flash memory cards, may also be used.

In this embodiment, the user interface provides menu driven selection, sorting, and playback of audio data files and display of elapsed playback time, volume level, and preset DSP mode. Additionally, prior to or after playback of an audio data file, the audio data player can play back the informational audio tag files associated with a selected audio data file in order to announce the selection. The audio tag file functions as part of a user interface, thereby allowing a user to select a particular audio data file, without having to view the LCD, by stepping through selections and listening to the announced information associated with audio data file.

One disclosed embodiment of the audio data player is a portable handheld unit having a rechargeable battery, 5 volt DC input, headphones output port, and line out port. Therefore, the audio data player can be used for portable applications using headphones, or for fixed applications using AC power and headphones or another audio device.

In one form thereof, a computer-readable medium having stored thereon a data structure is provided having a first audio data file having an information segment and an audio data segment, characterized in that the information segment stores at least a second audio data file encoding an audible announcement of an attribute of the audio data segment.

In another form thereof, a method of selecting an audio data file in a data device having a user interface including an audio output and a user input is provided, the method including providing an audio tag file encoding an audible announcement of an attribute of the associated audio data file; receiving a file navigation signal from the user input; in response to said file navigation signal, decoding and outputting to the audio output the audio tag file

In an additional form thereof, a method of associating audio tag voice files with an audio data file is provided, the method including altering the data structure of an audio tag voice file, and storing the audio tag voice file into the audio data file.

In yet another form thereof, an audio data player comprising a microcontroller coupled with data storage for storing an audio data file having an audio segment and an information segment, and an audio decoder is provided, the microcontroller has software capable of reading the information segment of a first audio data file, the microcontroller software being capable of locating at least a second audio data file embedded in the information segment.

In another form thereof, a method for reading and playing audio tag information files associated with an audio data file in a data processing device is provided, the method including locating an audio tag information file embedded in the tag information, and playing the audio tag information files.

One advantage of the present invention is that additional audio information relating to the contents of the audio data file may be embedded in the audio data file. Additionally, the audio information can be played by the audio data player and used to announce or select for playback an audio data file.

Another advantage of the present invention is that the additional audio information can be created as audio tag files in an MP3 format and stored in a data frame the ID3 tag. The audio information may advantageously include vocal recordings of tag information such as title, artist, album, year, and genre.

A further advantage of the present invention is that the audio tag files for a particular audio data file can be downloaded from an Internet or other server.

### BRIEF DESCRIPTION OF THE DRAWINGS

The above mentioned and other features and objects of this invention, and the manner of attaining them, will become more apparent and the invention itself will be better understood by reference to the following description of one embodiment of the invention taken in conjunction with the accompanying drawings, wherein:

FIG. 1 is a block schematic diagram of a portable audio data player according to the present invention;

FIG. 2 is a top view of a portable audio data player according to the present invention;

FIG. 3 is a front view of the portable audio data player of FIG. 2;

FIG. 4 is the right side view of the portable audio data player of FIG. 2;

FIG. 5 is a plan view of the main menu displayed on the audio data player of FIG. 2;

FIG. 6 is a flowchart diagram illustrating the steps for playing back an audio track using a portable audio data player according to the present invention;

FIG. 7 is a flowchart diagram illustrating the steps for creating an informational audio tag file; and

FIG. 8 is a flowchart diagram illustrating the steps of reading and playing an informational audio tag file.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates one embodiment of the invention, in one form, and such exemplifications are not to be construed as limiting the scope of the invention in any manner.

### DETAILED DESCRIPTION OF THE INVENTION

The embodiment disclosed below is not intended to be exhaustive or limit the invention to the precise form disclosed in the following detailed description. Rather, the embodiment is chosen and described so that others skilled in the art may utilize its teachings.

A data structure for storing digital audio data according to the present invention includes an information segment and an audio data segment. The exemplary embodiment is an improvement of MP3 files which are well known to those skilled in the art; however, the invention is not limited to the MP3 format but may be applied to other audio data file data structures. The information segment, such as an ID3 tag in an MP3 file, generally includes textual and graphical information related to the audio data segment of the audio data file. Examples of information related to the audio data segment include title, artist, album, year, comment, genre, lyrics, and pictures.

The information segment of the data structure in the exemplary embodiment includes one or more informational audio data files. The informational audio data files or audio tag files encode an audible recording announcing attributes of the audio data segment. For example, an included audio tag file may encode an audible recording announcing one or more of the textual information frames or fields contained in the informational segment, such as title, artist, album, year, and genre. Each audio tag file may advantageously be stored in a separate data frame of the information segment along with a data header specifying the type of frame and its contents.

In order to prevent an audio data player from inadvertently recognizing an audio tag file as a stand-alone audio data file, one or more of the audio tag file bits may be inverted before storing the audio tag file in the data frame of the information segment. Another method that may be used to prevent an audio player from inadvertently recognizing and playing an audio tag file is to modify one or more bits of the MPEG I/II/III frame header of the embedded audio tag file. The information needed to restore these modifications would be stored in the ID3 tag in a separate location, and retrieved as necessary by the data player. Thus, the typical structure of an audio data file is used for the audio tag file, and the audio tag file is sufficiently modified so that it will not be recognized as an audio data file but as a data frame of the information segment of the audio data file.

While the exemplary embodiment data structure uses audio tag files to vocalize the textual ID3 tag information of an MP3 file, any audible information related to the audio data file could be encoded and stored in audio tag files. Advantageously, voice files can be recorded at a lower bit rate than musical performance audio data file, and therefore are relatively small in size compared to the audio data file. The audio tag files can be played back on command or automatically based on user selection. For example, the audio tag files for an audio data file could be played back prior to or after the playback of the audio data segment of the audio data file. Thus, just as a radio announcer introduces or reports on a song, the audio tag files likewise introduce or report attributes of the audio data file. For voice audio tag files, famous celebrities or even the original performing artist could record the added voice tracks. Alternatively, voice synthesis could be used, such as a text-to-speech converter processing the textual information contained in the information segment of the audio data file. Also, an Internet service or other server configuration to be configured to automatically add audio tag files to existing audio data files. For example, the CDDB database that is available via the Internet for adding textual and graphic tag information to MP3 files.

Alternatively, audio tag files may be played every time forward skip or reverse skip is selected by the user of a playback device. Alternatively, the player may include a designated key, or a keystroke sequence, that allows the user to call up and playback the audio tag information at anytime during playback of a selected audio file. Upon activation of such a key, the playback of the selected audio file is muted, paused, or the volume is lowered, while the audio tag information is played back, and upon completion of the tag information the playback of the selected audio file continues as before. Such a feature would advantageously allow the user to obtain the audio tag information during playback of a track when it is difficult or inconvenient to obtain the associated information by looking at a visual display.

Additionally, multiple announcers could record the same or similar audio tag file so that a specific announcer may be randomly or intentionally selected for playback. While the exemplary embodiment is directed to portable audio data players, other embodiments may be directed to PC, Internet, or other data processing devices.

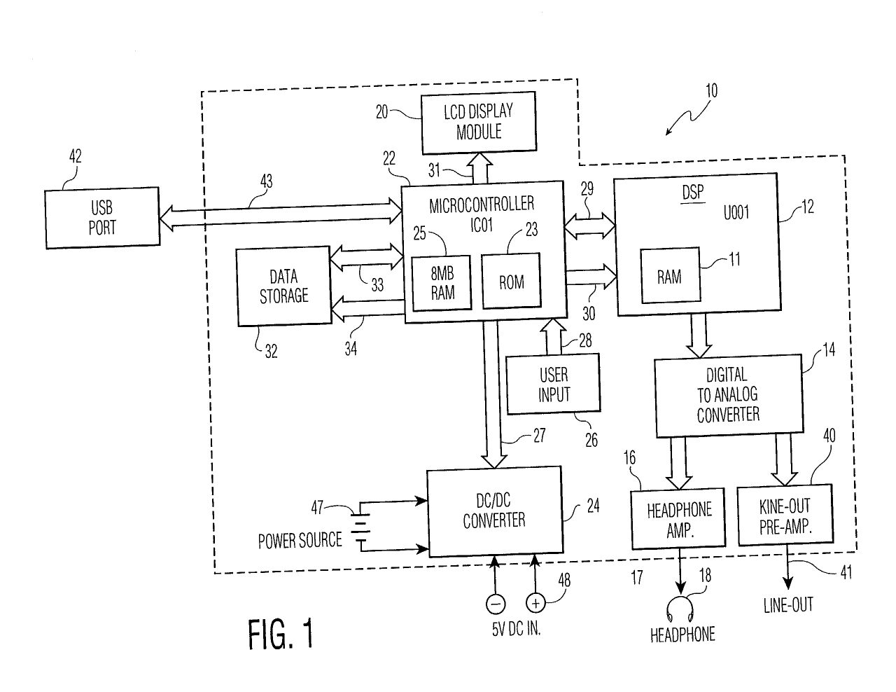

FIG. 1 shows a block diagram of portable audio data player 10 according to the present invention. The general arrangement and operation of the various elements are described hereinbelow. However, the details of the various elements of audio data player 10 are well known to those skilled in the art and will not be discussed here. Audio data player 10 comprises microcontroller 22 that controls the various elements and the overall operation of audio data player 10, including transferring data from data storage 32, through buffer memory 25, and to audio decoder DSP 12. Microcontroller 22 includes a suitable amount of memory 23, for storing various instruction sets and programs for controlling the operation of audio data player 10.

DSP 12 may be programmed to perform a variety of signal processing functions during playback of a selected audio data file. In this case, the functions that DSP 12 performs during playback include, but are not limited to, decoding audio data files, volume control, digital sound equalization, and sample conversion. In that regard, DSP 12 includes onboard memory 11, wherein the decoder files, audio data files, equalizer mode selection, and various other required data are loaded during playback.

The decoder files comprise programs that control the decoding operations of DSP 12 and the audio data files include data associated with the audio content. Both the audio data files and the decoder files are stored in data storage 32. The decoder file including the programs are transferred to DSP memory 11 from data storage 32.

Audio data and decoder programs stored in data storage 32 may be encrypted, requiring that decoding program files and audio data files be decrypted by DSP 12 using one or more decryption keys. The decryption keys may also be stored in data storage 32 and may be security linked to the particular storage device or some other coded component of audio data player 10 so that audio data files encrypted for use on a particular audio data player may only be decrypted and played by that particular audio data player.

As a selected audio data file is decoded, DSP 12 provides the decoded data stream to digital to analog converter 14. D/A converter 14 converts the digital output of DSP 12 into an analog signal and provides the analog signal to headphones amplifier 16 and lineout pre-amp 40. The analog signals are amplified and provided to lineout jack 41 and headphones jack 17, both disposed on housing 13 of audio player 10.

Audio player 10 is adapted to operate with data storage 32. In this embodiment, data storage 32 is a moving data storage device, specifically a hard drive, that can be used to store various data files, including encoded audio data files, decoder files for controlling the decoding operation of DSP 12, playlist files, and computer data files, such as, for example, word processing files, presentations, and spreadsheets. A large amount of data can be readily transferred between data storage 32 and microcontroller 22 through data bus 33. Buffer memory 25 operates as a circular data buffer to prevent interruption of audio playback caused by a skip or other similar moving data storage device data transfer delays. Using the present invention, decoder files, playlists, and relatively large amounts of audio data can be stored on data storage 32.

In accordance with the present invention, audio data files are loaded into data storage 32 via USB port 42 from a PC, or other similar device, using music management software that encodes the audio data files in accordance with a selected encoding format, such as MP3, or MP3 Pro, and then stores the encoded data files. Such music management software is implemented using programming methods known in the art. The music management software transmits the audio data files and appropriate decoder files to audio data player 10 across data buses 43 and 33 and into data storage 32. The music management software also generates, and modifies as necessary, a system configuration file and a file attribute table to provide information regarding the various data files and decoder files stored in data storage 32. Using the configuration file and the file attributes table, audio data player 10 is able to display audio data files sorted by various groupings on display 21, determine the correct encoding format for each audio data file, and download the appropriate decoder file for each content file in response to a user selection.

Music management software implementing the present invention may also embed audio tag files into the audio data file before transferring the file to audio data player 10. For example, an audio tag file associated with a particular audio data file can be altered to prevent inadvertent recognition of the audio tag file as a stand-alone audio data file, and then embedded into the informational segment of the audio data file. Specifically, by way of example, one or more bits of the audio tag file can be modified, for example, by inverting the bits, to alter the standard audio data file structure, such as an MP3 format, and then the altered file can be embedded as a data frame into an ID3 portion of the MP3 audio data file. Additionally, audio tag files can be created from processing tag information through a text-to-speech converter associated with the music management software, or by downloading audio tag files from a server.

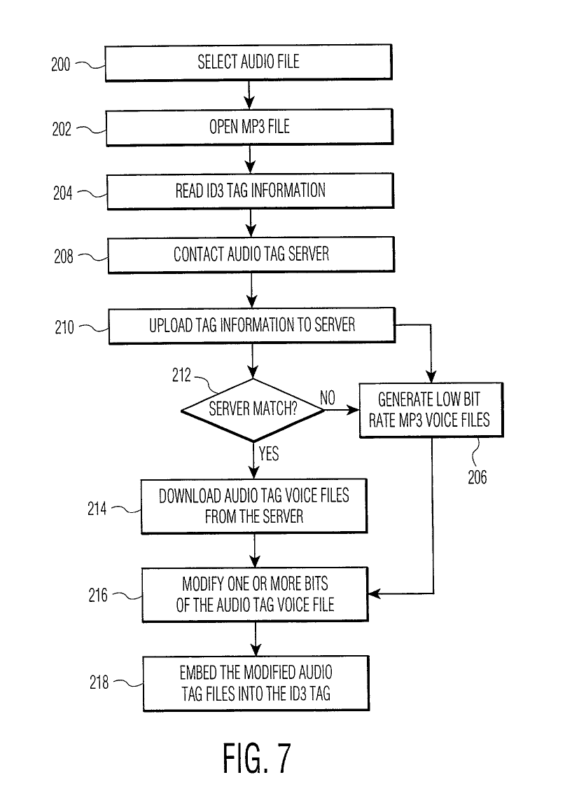

Referring to FIG. 7, in step 200 an MP3 or other audio data file is selected to which one or more audio tag files are to be added. In step 202, the MP3 file is opened in a data processing device. In step 204, textual ID3 tag information is read. In step 206, a text-to-speech converter or other voice synthesis is used to generate an audio tag voice file. Alternatively, the ID3 tag information read in step 204 can be used to uniquely identify the sound recording encoded in the audio data file to download audio tag files from an Internet or other server. In step 208, an audio tag server is contacted by the data processing device. In step 210, the ID3 tag information necessary to find matching audio data files is uploaded from the data processing device to the server. In step 212, it is determined whether matching audio tag files are available on the server. If not, audio tag files are generated at step 206. If matches are found, audio tag files are downloaded from the server to the data processing device in step 214. Audio tag files may be, for example, a low bit rate MP3 voice files corresponding to each of the textual ID3 tag fields. In step 216, one or more bits of the audio tag files can be modified to prevent inadvertent recognition of an embedded audio tag file as a stand-alone audio data file. In step 218, the altered audio tag files are embedded into the information segment of the audio data file. For example, an altered MP3 voice file can be embedded in a data frame in the ID3 tag area along with a frame header to identify the files and their lengths.

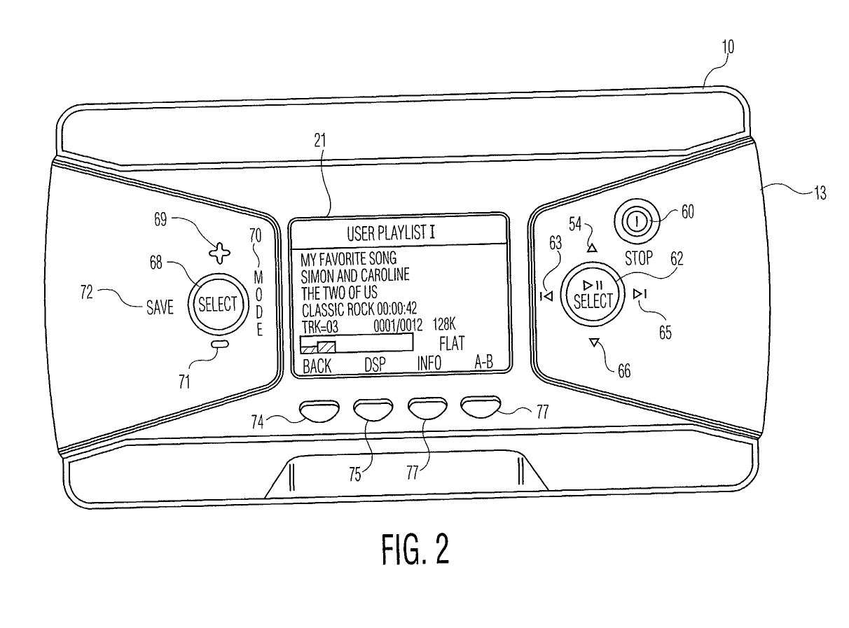

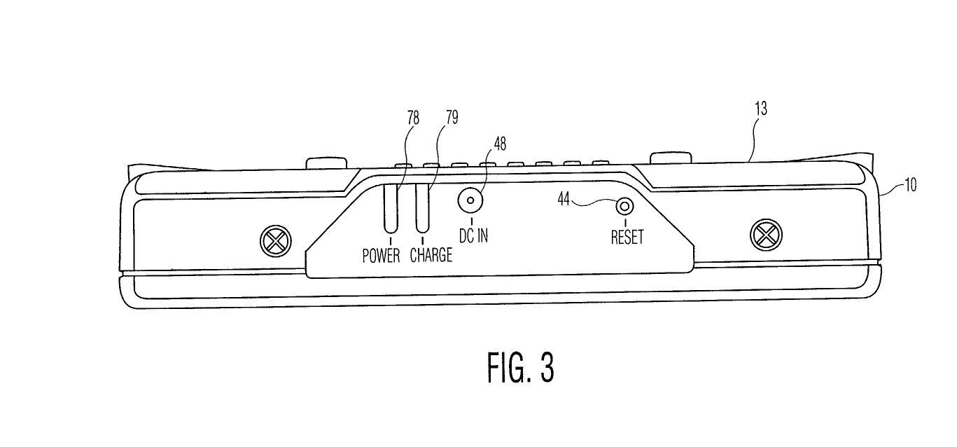

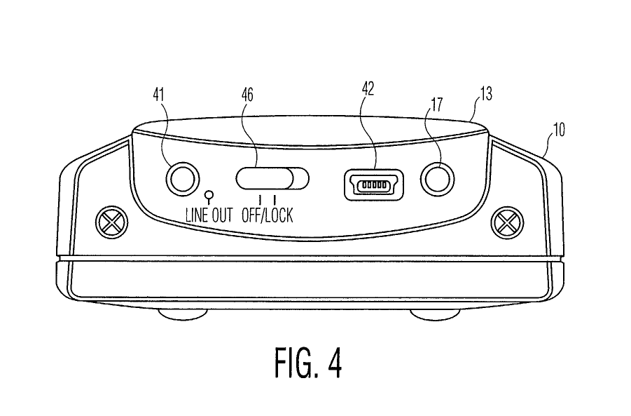

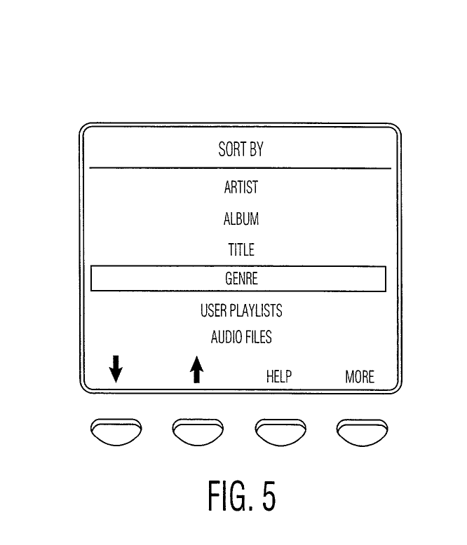

FIGS. 2-4 illustrates additional aspects of the exemplary embodiment of audio data player 10, specifically, the displays, buttons, switches, indicators, and ports which may be disposed on housing 13 of audio data player 10. Referring to FIG. 2, user input 26 comprises a plurality of buttons 44 (FIG. 3), 46 (FIG. 4), and 60-77 disposed on housing 13 of audio data player 10 for allowing a user to sort and select particular audio data files for playback, and to control playback settings. User input 26 may also comprise other input devices known in the art, for example, keyboard, voice activated touch pad, and touch screen input devices. Two multi-way switches comprise buttons 62-66 and 68-72. Soft keys 74-77 are multi-function buttons whose function change for various user interface menu displays. Audio data player 10 also includes display 21 disposed on housing 13. Display 21 displays the audio data files and playlists stored in data storage 32, the function of soft keys 74-77, and various status information associated with audio data player 10, such as the playback status shown in FIG. 2 and the top-level menu shown in FIG. 5.

Referring again to FIG. 2, STOP/POWER button 60 allows the user to stop playback and to turn audio data player 10 on and off. PLAY/PAUSE button 62 allows the user to start playback and to pause playback. Left arrow button 63 allows a user to move a highlight left when using the menu, and to skip back to the previous audio data file or scan backward in the present audio data file when playing music. The right arrow button 65 allows the user to move a highlight right when using the menu, skip forward to the next audio data file, and scan forward in the current audio data file when playing music. Up arrow button 64 allows the user to move the highlight up when using the menu. Down arrow button 66 allows the user to move the highlight down when using the menu.

Referring still to FIG. 2, SELECT button 68 allows the user to select a highlighted item. Volume up button 69 increases the playback volume level for headphones 18 and volume down button 71 decreases the volume level. MODE button 70 allows the user to select a particular playback mode, including NORMAL, REPEAT, REPEAT ONE, REPEAT ALL, SHUFFLE, and REPEAT ALL SHUFFLE. SAVE button 72 allows a user to create a new playlist or add audio data files to an existing playlist. Soft keys 74-77 select the menu item that appears just above each button at the bottom of display 21.

Referring to FIG. 3, POWER indicator 78 lights when audio data player 10 is on. CHARGE indicator 79 lights when the power source 47 is charging. In the exemplary embodiment, power source 47 is a rechargeable battery pack. DC IN jack 48 provides 5 volt DC from an AC adapter to power audio data player 10 and recharge power source 47. RESET button 44 allows the user to reset all of the audio data player settings to the factory defaults.

Referring now to FIG. 4, OFF/LOCK switch 46 allows the user to make buttons 60-77 inactive when switch 46 is slid to the locked position. LINE OUT jack 41 allows a user to connect the audio data player to a separate audio system. Headphones jack 17 allows the user to play the decoded audio on headphones 18. USB port 42 provides connection of audio data player 10 to a PC or other similar device using a USB cable.

When the user selects a particular audio data file for playback via user input, microcontroller 22 loads the appropriate decoder file associated with the selected audio data file from data storage 32 into DSP memory 11. Referring again to FIG. 1, microcontroller 22 then streams the selected audio data file along buses 33 and 29 into DSP 12, using buffer memory 25 as a skip-protection buffer.

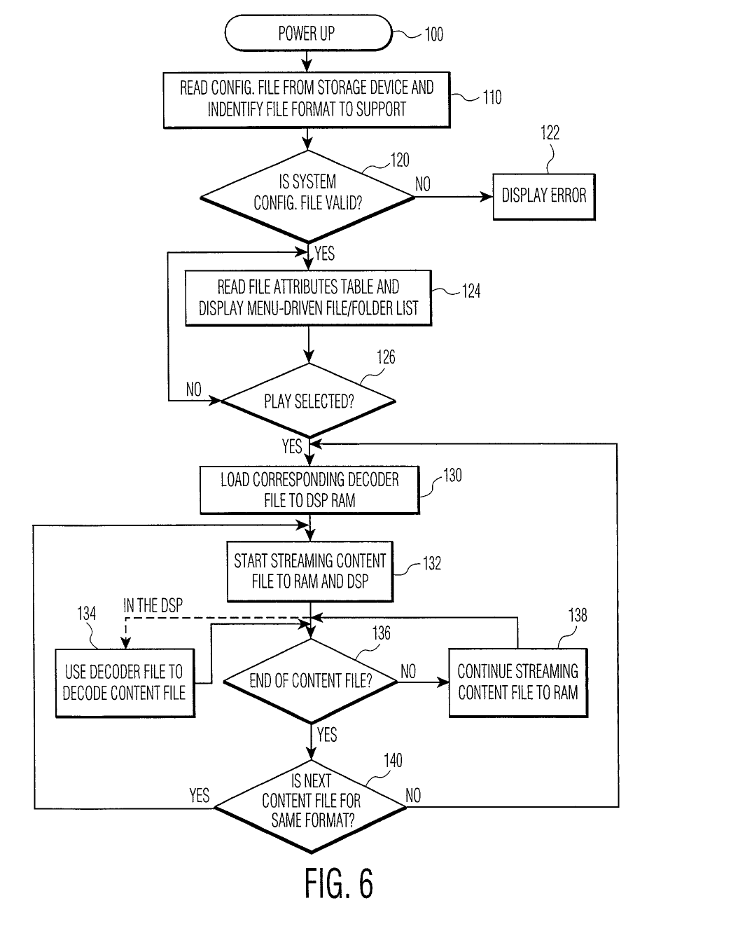

After streaming of the selected audio data file begins, DSP 12 decodes the audio data file using the associated decoder file. The decoder files stored in data storage 32 allow audio player 10 to be adapted to process the various encoding formats associated with the audio data files stored in data storage 32. In effect, portable audio player 10 is software upgraded, as necessary, by the decoder files stored in data storage 32 when the user selects a particular audio data file stored in data storage 32. The steps associated with processing a selected audio data file from data storage 32 using audio data player 10 is shown in the flowchart of FIG. 6, and described below.

FIG. 6 shows a flowchart illustrating the steps for processing a selected audio data file in accordance with the present invention. After powering up in step 100, microcontroller 22 of audio data player 10 loads the system configuration file from data storage 32, in step 110. Also in step 110, microcontroller 22 identifies the various file formats that need to be supported for the data files stored in data storage 32. The configuration file also includes information that equates the file extension of the audio data files with particular decoder files stored in data storage 32. In step 120, if a configuration file is not valid, microcontroller 22 causes an error indication to be displayed, step 122, on display 21. In step 124, if the configuration file is valid, microcontroller 22 reads the file attribute table stored in data storage 32 and causes display 21 to display a menu-driven listing of the file/folders stored in data storage 32.

Referring to FIG. 5, the main menu displayed on display 21 allows the user to navigate and display audio data files according to groupings or identifying characteristics, such as, for example, artist, album, title, genre, playlist, and all audio data files. From the main menu, the user may operate user input 26, as described above, to navigate sorted lists and select a desired one of the displayed audio data files or playlists for playback.

When an audio data file or playlist is selected for playback in step 126, microcontroller 22 and DSP 12 perform a number of steps, including several concurrent steps, to provide audio playback. First, microcontroller 22 identifies and transfers the corresponding decoder file from data storage 32 to DSP memory 11 in step 130. For example, if the user selects an MP3 file, microcontroller 22 transfers the MP3 decoder file from data storage 32 to DSP memory 11. The MP3 decoder file is used to control the decoding operation of DSP 12.

In step 132, microcontroller 22 begins streaming the selected audio data file from data storage 32 through buffer memory 25 to DSP 12. In step 134, DSP 12 uses the decoder file to decode and decrypt, if applicable, the audio data file in accordance with the appropriate encoding format. The decoded audio data is provided to D/A converter 14 and headphone amp 16 and line out pre amp 40 for reproduction.

In step 136, it is determined whether all of the data in the selected audio data file has been transferred to buffer memory 25. If not, in step 138, microcontroller 22 continues to stream data from data storage 32 to buffer memory 25. If the transfer of data is complete as determined in step 136, microcontroller 22 determines in step 140 whether the next audio data file is encoded using the same format as the previous audio data file. If the encoding format of the next audio data file is the same as the previous encoding format, microcontroller 22 returns to step 132 and starts streaming the data from the next audio data file, which data is subsequently decoded in step 134 as before.

If the encoding format of the next audio data file differs from the encoding format of the previous audio data file, microcontroller 22 returns to step 130. In this case, a new decoder file associated with the next audio data file is transferred to DSP memory 11, and the steps of streaming the audio data file and decoding the data file using the newly loaded decoder file is repeated. In this manner, audio data player 10 is able to playback audio data files encoded using any one of a plurality of encoding formats, as long as the decoder file associated with the selected encoding format is available and can be downloaded onto DSP memory 11. In the present embodiment, the necessary decoder files are stored in data storage 32 along with the audio data files. As such, audio player 10 can be updated to play different encoding formats by software updating of the DSP via decoder files stored along with the audio data files in data storage 32. Thus, audio data player 10 is capable of playing back data files encoded using a variety of encoding formats, including encoding formats that become available in the future.

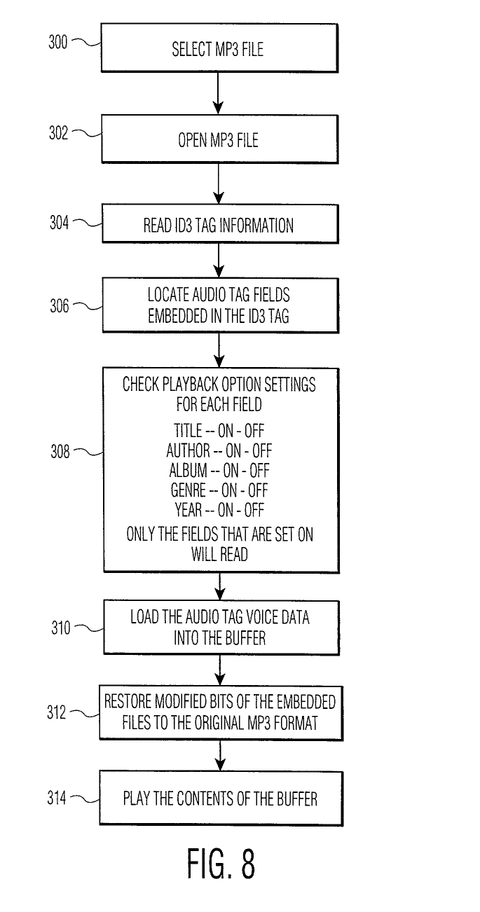

Referring to FIG. 8, a method of reading and playing audio tag files is shown. Although the disclosed method can be performed in audio data player 10, other data processing devices such as a PC or personal data assistant (PDA) may also be used. In step 300, an audio data file is selected, such as an MP3 file. In step 304, the audio data file is opened in the data processing device. In step 304, the information segment of the audio data file is read, for example, the ID3 tag in an MP3 file. In step 306, the audio tag files embedded in the information segment are located. In step 308, a determination is made of which audio tag files are selected for playback. For example, the user may select playback of one or more of various audio tag files that correspond to tag information such as title, author, album, genre, and year. In step 310, those audio tag files that were determined in step 308 to have been selected for playback will be loaded into the playback cue or buffer of the data processing device. In step 312, the audio data files are modified to return them to a playable audio data file format. For example, in the exemplary embodiment, one or more bits of the audio tag files must be restored to their original states so that the audio tag files conform to a playable MP3 format. In step 314, the contents of the audio tag files in the playback buffer are processed and played in the same way that other audio data files are.

Advantageously, audio data devices such as audio data player 10 are configured with software to locate and read audio tag files in accordance with the disclosed data structure, and to recognize and play back the audio tag files. Additionally, audio data devices that are not configured to recognize audio tag files can still play back audio data files having embedded audio tag files; however, such audio data devices cannot play back the audio tag file portions.

The exemplary embodiment of audio data player 10 advantageously utilizes the audio tag files with user input 26 and audio output via headphone output 17 or lineout 41 to provide a user interface for navigating and selecting a list of audio data files without having to view display 21. In the exemplary embodiment, audio data player 10 is configured to play back at least one of the audio tag files associated with each audio data file when the user navigates to each audio data file in the list. Thus, by using various buttons of user input 26, for example, up arrow button 64 and down arrow button 66, shown in FIG. 2, the user can navigate the list of audio data files. As a file navigation signal from user input 26 is received, the audio tag files associated with the navigated to audio data file are played for the user. When the user has navigated to the desired audio data file, SELECT button 68 or another of user input 26 activates a file selection signal resulting in the decoding and playing of the selected audio data file. This allows the user to obtain information about the files being played without requiring the user to look at display 21.

In the exemplary embodiment, suitable microcontrollers 22 include, but are not limited to, μPC78A4036 manufactured by NEC Corporation. Associated with microcontroller 22 is memory 23, in this case, 48 KB of ROM, and buffer memory 25 comprising 8 MB of RAM, providing 7 minutes of buffered play time at 128 kbps and 14 minutes of buffered play time at 64 kbps. Suitable DSP units 12 include, but are not limited to, TMS320NC5410 manufactured by Texas Instruments, Inc., of Dallas, Tex. DSP 12 also includes associated memory 11, in this case 64 KB of RAM. Suitable hard drives for data storage 32 include, but are not limited to, Microdrive™ manufactured by IBM Corporation of Armonk, N.Y. A 10 GB hard drive, for example, provides approximately 150 hours of audio at MP3 bit-rate of 128 kbps, or 300 hours at a bit-rate of 64 kbps.

It will be apparent to those skilled in the art that although the present invention has been described in terms of an exemplary embodiment, modifications and changes may be made to the disclosed embodiment without departing from the essence of the invention. For example, although the present invention has been described with reference to data storage 32 that is fixedly disposed within audio player 10, the present invention may be implemented using flash memory, another fixed storage device, optical device, or a memory card that is adapted to be coupled, either detachably or fixedly, to audio player 10, wherein the decoder program and audio data files are loaded onto the memory card by the music management software. Also, it is herein recognized that the present feature of loading the appropriate decoder programs and the audio data files may be implemented in the music management software using any one of a number of conventionally known programming methods, or combination of programming methods. Also, although the above is described in reference to an audio data player, the present invention may be extended to any portable data processing device, for example, video display devices, wherein the data may be encoded using one of a plurality of data encoding formats. Therefore, it is to be understood that the present invention is intended to cover all modifications as defined in the appended claims.

What is claimed is:

1. In a data device having a user interface including an audio output and a user input, a method of processing an audio data file, comprising the steps of:
selecting and retrieving an audio data file for playback in response to a user input;
identifying audio tag information associated with the selected audio data file, the audio tag information including an audible announcement of an attribute of the associated audio data file;
decoding and processing the audio data file to provide an audible output; and
decoding and processing the audio tag information to provide the audible announcement of the attribute of the selected audio data file in response to a user input.

2. The method of claim 1, wherein
the selected audio data file is encoded in the MP3 format and the audio tag information is included in the ID3 tag portion of the audio data file.

3. The method of claim 2, wherein
the audio tag information decoding step comprises decoding and processing the audio tag information to provide the audible announcement immediately prior to beginning playback of the selected audio data file.

4. The method of claim 2, wherein
the audio tag information comprises an audio tag voice file that announces the attribute of the selected audio data file.

5. The method of claim 2, wherein
the audio tag information is a modified version of an MP3 formatted file, and the audio tag information decoding step comprises restoring the audio tag information to the MP3 format, and decoding and processing the restored file in accordance with the MP3 standard.

6. The method of claim 5, wherein
the modification comprises inverting the bits of the audio tag information.

7. A method of associating audio tag voice files with an audio data file, comprising the steps of:
receiving an audio tag voice file that is encoded in the same format as the audio data file;
altering the data structure of the encoded audio tag voice file; and
storing the altered audio tag voice file into an identifying information portion of the audio data file.

8. The method of claim 7, wherein
the receiving step comprises receiving the audio tag voice file corresponding to the audio data file from a remotely located server via a public communications network.

9. The method of claim 7, wherein
the receiving step comprises receiving an audio tag voice file encoded according to the MP3 format and the storing step comprises storing the encoded audio tag voice into the ID3 tag portion of the audio data file.

10. The method of claim 7, wherein
the receiving step comprises receiving the audio tag voice file associated with the information attribute from a text-to-voice converter.

11. An audio data player, comprising:
a data storage device for storing a plurality of audio data files;
a digital signal processor for decoding a selected audio data file to provide an output signal;
user input for accepting user input commands; and
a microcontroller, coupled to the data storage device, the digital signal processor, and the user input, for causing a selected audio data file to be decoded, processed, and provided to an output device in response to user input, the microcontroller adapted to identify an audio tag file included in an identifying information portion of the selected audio data file and cause the audio tag file to be decoded and processed in response to a user input.

12. The audio data player of claim 11, wherein
the microcontroller is adapted to identify an audio tag file that has been encoded, in the same format as the selected audio data file, and then modified, the microcontroller causing the audio tag file to be restored, and then decoded and processed according to the same encoding/decoding format as the selected audio data file.

13. The audio data player of claim 11, wherein
the selected audio data file and the audio tag file are encoded in the MP3 format and the audio tag file is stored in the ID3 portion of the selected audio data file.

14. The audio data player of claim 13, wherein
the microcontroller is adapted to mute, pause, or lower the volume associated with playback of the selected audio data file, and to cause playback of the audio tag file in response to a user input to playback the audio tag file.

15. The audio data player of claim 13, wherein
the microcontroller is adapted to cause playback of the audio tag file immediately prior to beginning playback of the selected audio data file in response to a command to playback the selected audio data file.

16. The audio data player of claim 11, wherein
the audio tag files comprises a plurality of audio tag files, each audio tag file associated with a different announcer or a different attribute of the selected audio data file, and the microcontroller selects one of the plurality of audio tag files for playback in response to user selection of the audio data file.

17. A computer-readable medium having stored thereon a data structure, having a first audio data file having an information segment and an audio data segment, wherein the information segment stores at least a second audio data file encoding an audible announcement of an attribute of said audio data segment.

18. The data structure of claim 17, wherein
the first audio data file is encoded according to the MP3 format and the information segment comprises an ID3 tag portion of the first audio data file.

19. The data structure of claim 18, wherein
the second audio data file is encoded according to the MP3 format and is stored in a data frame of the ID3 tag.

20. The data structure of claim 17, wherein
at least one bit of the second audio data file is inverted.
